(19) United States
(12) Patent Application Publication
(10) Pub. No.: US 2008/0031518 A1
(43) Pub. Date: Feb. 7, 2008

(54) Method and apparatus for encoding/decoding color image

(75) Inventors: Byung-cheol Song, Suwon-si (KR); Kang-wook Chun, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,169

(22) Filed: Apr. 6, 2007

(30) Foreign Application Priority Data
Aug. 2, 2006 (KR) 10-2006-0072950

(51) Int. Cl. G06T 9/00

(52) U.S. Cl. 382/166; 382/249

(57) ABSTRACT

Provided are a method and an apparatus for encoding and decoding a color image. The method of encoding a color image includes generating a color transformation function for color format transformation for each block of the color image, performing color transformation on each block of the color image using the generated color transformation function, and performing encoding on each block of the color-transformed image.

### CROSS-REFERENCE TO RELATED PATENT APPLICATION

This application claims priority from Korean Patent Application No. 10-2006-0072950, filed on Aug. 2, 2006 in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding of a color image, and more particularly, to encoding and decoding a color image using color transformation.

2. Description of the Related Art

Moving Picture Experts Group (MPEG) video compression standard H.264 or MPEG 4 Advanced Video Coding (AVC), which has been in the spotlight recently, employs various compression techniques. For example, unlike conventional coding standards, H.264 or MPEG 4 AVC uses various techniques for improving compression efficiency, such as multi reference motion compensation, loop filtering, variable block size motion compensation, and entropy encoding like context-adaptive binary arithmetic coding (CABAC).

In particular, H.264 or MPEG 4 AVC includes video encoding in an RGB space instead of a color space of YCbCr. This feature is as a result of research whereby a video format generated when capturing an image uses an RGB color format and a limitation in display quality occurs when the RGB color format is transformed into a YCbCr format for encoding.

Thus, many techniques for improving the efficiency of encoding in an RGB 4:4:4 space instead of a YCbCr 4:4:4 space have been suggested, one of which is a residual color transformation (RCT). In addition, YCoCg and YFbFr formats having superior performances over the YCbCr format and using a Karhunen Loeve (KL) transform have been proposed, and video encoding methods using one of these formats have been suggested.

An encoding method using an RCT may be implemented by incorporating an RCT unit into an H.264 video encoder.

For example, when an RGB 4:4:4 image input into an encoder is encoded, an RCT using correlation between RGB in a residue area may be performed prior to an integer transform. The residue refers to a difference between the original input image and a predicted image. When the input image includes three color component images of red (R), green (G), and blue (B), residue values ΔR, ΔG, and ΔB of the color component images can be expressed as follows:

ΔR=R−Rₚ

ΔG=G−Gₚ

ΔB=B−Bₚ (1)

where R, G, and B indicate color component images of the input image, and Rₚ, Gₚ, and Bₚ indicate predicted images of the R, G, and B color component images. A first residue block indicates a difference between an input pixel block of predetermined-size of each color component image and a predicted pixel block obtained by performing predictive encoding on the input pixel block. In other words, the first residue block is a block which is generally referred to as a residue block in the field of video processing and corresponds to a difference between an input pixel block and a predicted pixel block.

The RCT is based on the fact that residue information of R, G, and B, which is generated after intra prediction or motion compensation, still has correlation. The residue ΔR of the R component, the residue ΔG of the G component, and the residue ΔB of the B component have a high correlation, which is used for the RCT.

The RCT in H.264 is defined as follows:

Δ²R=ΔR−ΔB

t=ΔB+(Δ²R>>1)

Δ²B=ΔG−t

Δ²G=t+(Δ²B>>1) (2),

where ΔX indicates first residues, Δ²X indicates second residues that are differences between the first residues, ‘>>’ indicates a right shift operation and is approximately equivalent to division by 2, and t is a variable temporarily used for calculation.

An inverse RCT is defined as follows:

t=Δ²G−(ΔB′>>1)

ΔG′=Δ²B′+t

ΔB′=t−(Δ²R′>>1)

ΔR′=Δ²R′+ΔB′) (3),

where ΔX′ indicates a reconstructed first residue, and Δ²X′, indicates a reconstructed second residue.

The RCT is intended for direct encoding in an RGB area so as to overcome a display quality limitation in YCbCr encoding. Since YCbCr is not optimal for color format transformation, new color transforms such as a YCoCg-R transform and a YFbFr transform have been suggested.

The following equations show the YCoCg-R transform and the YFbFr transform functions, respectively.

$$\begin{matrix}[ \begin{matrix}Y \\ Co \\ Cg\end{matrix} ] = [ \begin{matrix}1 / 4 & 1 / 2 & 1 / 4 \\ 1 & 0 & - 1 \\ - 1 / 2 & 1 & - 1 / 2\end{matrix} ] [ \begin{matrix}R \\ G \\ B\end{matrix} ] & ( 4 ) \\ [ \begin{matrix}Y \\ Fb \\ Fr\end{matrix} ] = [ \begin{matrix}5 / 16 & 3 / 8 & 5 / 16 \\ - 1 / 2 & 1 & - 1 / 2 \\ 1 & 0 & - 1\end{matrix} ] [ \begin{matrix}R \\ G \\ B\end{matrix} ] & ( 5 )\end{matrix}$$

However, related art video encoding methods do not fully reflect the characteristics of lossy coding. Furthermore, since an input RGB image is transformed into a single color transformation format for encoding, the local characteristic of the image is not reflected.

### SUMMARY OF THE INVENTION

The present invention provides a method and apparatus for encoding and decoding a color image using adaptive color transform.

According to an aspect of the present invention, there is provided a method of encoding a color image. The method includes generating a color transformation function for color format transformation for each block of the color image, performing color transformation on each block of the color image using the color transformation function, and performing encoding on each block of the color-transformed image.

According to another aspect of the present invention, there is provided a method of encoding a color image. The method includes selecting a color transformation function from a plurality of color transformation functions for color format transformation for each block of the color image, performing color transformation on each block of the color image using the color transformation function, and performing encoding on each block of the color-transformed color image.

According to another aspect of the present invention, there is provided a method of decoding a color image. The method includes receiving the color image composed of blocks undergoing color transformation and encoding, performing decoding corresponding to the encoding on the color image, generating an inverse color transformation function for color format transformation for each of the blocks of the color image, and performing inverse color transformation on each of the blocks of the color image using the inverse color transformation function.

According to another aspect of the present invention, there is provided a method of decoding a color image. The method includes receiving a color image stream including a color image composed of blocks undergoing color transformation and encoding and mode information specifying the color transformation applied to each of the blocks of the color image, performing decoding corresponding to the encoding on each of the blocks of the color image stream, selecting an inverse color transformation function from a plurality of inverse color transformation functions for color format transformation for each of the blocks of the color image based on the mode information, and performing inverse color transformation on each of the blocks of the color image using the inverse color transformation function.

According to another aspect of the present invention, there is provided an apparatus for encoding a color image. The apparatus includes a color transformation function generation unit that generates a color transformation function for color format transformation for each block of the color image, a color transformation unit that performs color transformation on each block of the color image using the color transformation function, and an encoding unit that performs encoding on each block of the color-transformed image.

According to another aspect of the present invention, there is provided an apparatus for encoding a color image. The apparatus includes a color transformation function selection unit that selects a color transformation function from a plurality of color transformation functions for color format transformation for each block of the color image, a color transformation unit that performs color transformation on each block of the color image using the color transformation function, and an encoding unit that performs encoding on each block of the color-transformed color image.

According to another aspect of the present invention, there is provided an apparatus for decoding a color image. The apparatus includes a decoding unit that receives the color image composed of blocks undergoing color transformation and encoding and performs decoding corresponding to the encoding on the color image, and an inverse color transformation unit that generates an inverse color transformation function for color format transformation for each of the blocks of the color image and performs inverse color transformation on each of the blocks of the color image using the inverse color transformation function.

According to another aspect of the present invention, there is provided an apparatus for decoding a color image. The apparatus includes a decoding unit that receives a color image stream including a color image composed of blocks undergoing color transformation and encoding and mode information specifying the color transformation applied to each of the blocks of the color image and performs decoding corresponding to the encoding on each of the blocks of the color image stream, and an inverse color transformation unit that selects an inverse color transformation function from a plurality of inverse color transformation functions for color format transformation for each of the blocks of the color image based on the mode information and performs inverse color transformation on each of the blocks of the color image using the inverse color transformation function.

According to another aspect of the present invention, there is provided a computer readable recording medium storing a computer program for performing a method of encoding a color image. The method includes generating a color transformation function for color format transformation for each block of the color image, performing color transformation on each block of the color image using the color transformation function, and performing encoding on each block of the color-transformed image.

According to another aspect of the present invention, there is provided a computer readable recording medium storing a computer program for performing a method of encoding a color image. The method includes selecting a color transformation function from a plurality of color transformation functions for color format transformation for each block of the color image, performing color transformation on each block of the color image using the color transformation function, and performing encoding on each block of the color-transformed color image.

According to another aspect of the present invention, there is provided a computer readable recording medium storing a computer program for performing a method of decoding a color image. The method includes receiving the color image composed of blocks undergoing color transformation and encoding, performing decoding corresponding to the encoding on the color image, generating an inverse color transformation function for color format transformation for each of the blocks of the color image, and performing inverse color transformation on each of the blocks of the color image using the inverse color transformation function.

According to another aspect of the present invention, there is provided a computer readable recording medium storing a computer program for performing a method of decoding a color image. The method includes receiving a color image stream including a color image composed of blocks undergoing color transformation and encoding and mode information specifying the color transformation applied to each of the blocks of the color image, performing decoding corresponding to the encoding on each of the blocks of the color image stream, selecting an inverse color transformation function from a plurality of inverse color transformation functions for color format transformation for each of the blocks of the color image based on the mode information, and performing inverse color transformation on each of the blocks of the color image using the inverse color transformation function.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a video encoder using block adaptive color transformation (BACT) according to an exemplary embodiment of the present invention;

FIGS. 2A, 2B, and 2C illustrate neighboring reconstructed pixels of a current block for explaining an exemplary embodiment of the present invention;

FIG. 3 is a block diagram of a BACT unit according to an exemplary embodiment of the present invention;

FIG. 4 is a block diagram of a video encoder according to another exemplary embodiment of the present invention;

FIG. 5 is a flowchart illustrating a video encoding method implemented by the video encoder illustrated in FIG. 1;

FIG. 6 is a block diagram of a video encoder using BACT according to another exemplary embodiment of the present invention;

FIG. 7 is a flowchart illustrating a video encoding method implemented by the video encoder illustrated in FIG. 6;

FIG. 8 is a block diagram of a video encoder using BACT according to another exemplary embodiment of the present invention;

FIG. 9 is a flowchart illustrating a video encoding method implemented by the video encoder illustrated in FIG. 8;

FIG. 10 is a block diagram of a video decoder according to an exemplary embodiment of the present invention;

FIG. 11 is a block diagram of a video decoder according to another exemplary embodiment of the present invention;

FIG. 12 is a flowchart illustrating a video decoding method implemented by a video decoder illustrated in FIG. 10; and

FIG. 13 is a flowchart illustrating a video decoding method implemented by a video decoder illustrated in FIG. 11.

### DETAILED DESCRIPTION OF EXEMPLARY EMBODIMENTS OF THE INVENTION

Hereinafter, exemplary embodiments of the present invention will be described in detail with reference to the accompanying drawings.

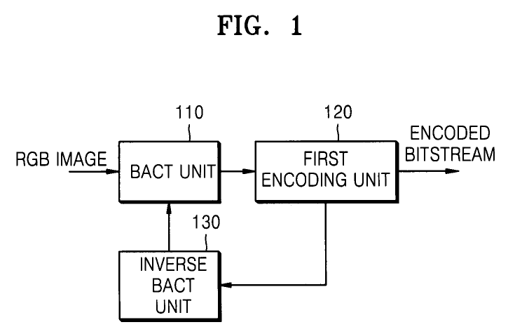

FIG. 1 is a block diagram of a video encoder using BACT according to an exemplary embodiment of the present invention.

Referring to FIG. 1, the video encoder includes a BACT unit 110, a first encoding unit 120, and an inverse BACT unit 130.

The BACT unit 110 obtains the optimal color transformation function for each predetermined block, performs color transformation on the predetermined block, and outputs the resulting video data to the first encoding unit 120. Here, the first encoding unit 120 is an encoder that complies with H.264 or MPEG4 AVC, but it may be an arbitrary encoder for selectively encoding video data.

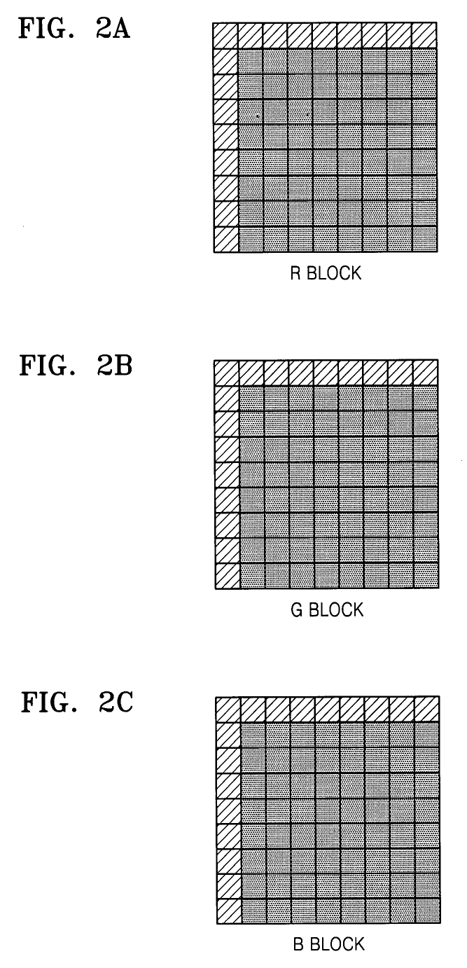

FIGS. 2A, 2B, and 2C illustrate neighboring reconstructed RGB values used to obtain a color transformation function for an 8×8 block, in which dashed pixels are used to obtain the optimal color transformation function for a current input RGB 8×8 block. FIG. 2A illustrates neighboring reconstructed pixels used for a current R block, FIG. 2B illustrates neighboring reconstructed pixels used for a current G block, and FIG. 2C illustrates neighboring reconstructed pixels used for a current B block. The neighboring reconstructed pixels have neighboring reconstructed RGB values that are obtained by encoding and decoding in the first encoding unit 120 and processing in the inverse BACT unit 130 and are input to the BACT unit 110.

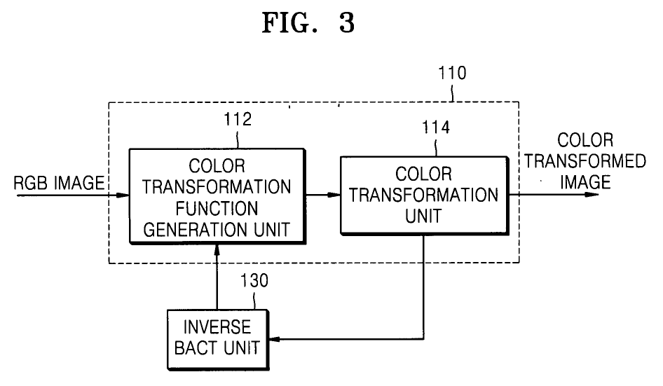

FIG. 3 is a block diagram of the BACT unit 110 according to an exemplary embodiment of the present invention. Referring to FIG. 3, the BACT unit 110 includes a color transformation function generation unit 112 and a color transformation unit 114.

Hereinafter, a color transformation function generation process in the color transformation function generation unit 112 according to an exemplary embodiment of the present invention will be described.

The dashed neighboring RGB values of FIGS. 2A through 2C input from the inverse BACT unit 130 are normalized as follows:

$$R = \frac{r - {μ}_{r}}{{σ}_{r}} , G = \frac{g - {μ}_{g}}{{σ}_{g}} , B = \frac{b - {μ}_{b}}{{σ}_{b}} , \qquad ( 6 )$$

where μₓ (X may be r, g, or b) indicates an average for each component of the neighboring RGB values, and σₓ (X may be r, g, or b) indicates a standard deviation for each component of the neighboring RGB values.

Next, an auto-correlation matrix is obtained using normalized RGB values for the current block as follows:

$${R}_{X} = [ \begin{matrix}{σ}_{R}^{2} & {μ}_{RG} & {μ}_{RB} \\ {μ}_{RG} & {σ}_{G}^{2} & {μ}_{GB} \\ {μ}_{RB} & {μ}_{GB} & {σ}_{B}^{2}\end{matrix} ] , \qquad ( 7 )$$

where μ_{RG} indicates an average of products of R values and G values, μ_{RB} indicates an average of products of R values and B values, and μ_{GB} indicates an average of products of G values and B values. σ²_{R} indicates a dispersion of the R values, σ²_{G} indicates a dispersion of the G values, and σ²_{B} indicates a dispersion of the B values.

Next, an eigenvector and an eigenvalue can be obtained using the obtained auto-correlation matrix Rₓ as follows:

RₓΘ=ΘΛ (8),

where Θφ₁φ₂φ₃) and Θ is a set of eigenvectors, and Λ indicates a diagonal matrix having eigenvalues as diagonal terms.

As such, the eigenvector Θ can be obtained using Equations 6, 7, and 8 from the dashed neighboring reconstructed RGB values of FIGS. 2A through 2C. Θ^{T} can be obtained by transposing the eigenvector Θ.

Since Θ^{T} is normalized with an L2 norm, it is necessary to normalize each row with an L1 norm to maintain the same dynamic range after color transform. Here, the dynamic range means a range in which a value exists. For example, an 8-bit Y value theoretically has a value ranging from 0 to 255, but in practice, a value only between 50 and 200 can exist in a specific image or area that is referred to as the dynamic range. Here, the L2 norm is the square root of a sum of the squares of elements of a specific vector, and the L1 norm is a sum of the absolute values of the elements of the specific vector. A matrix Θ_{L1}^{T} obtained by normalizing Θ^{T} with the L1 norm is the optimal color transformation matrix based on the neighboring reconstructed RGB values. An inverse color transformation matrix is an inverse matrix of the obtained color transformation matrix.

Predetermined offset values may be applied to the obtained matrix Θ_{L1}^{T} in order for a chroma component to exist between 0 and 255.

In order to adjust a bit precision of data during first encoding, forward transform may be multiplied by 2 and backward transform may be divided by 2. Here, the bit precision means the number of bits of video data. The bit precision of general luminance data is 8 bits.

The BACT unit 110 generates a color transformation matrix that can be adaptively applied to each unit block, i.e., a color transformation function for color format transform, and performs color transformation using the generated color transformation function.

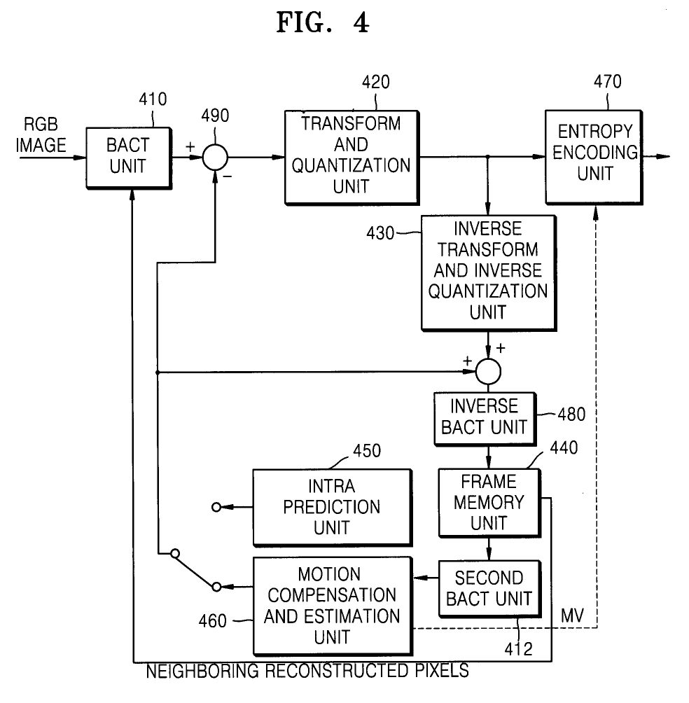

FIG. 4 is a block diagram of a video encoder in which the first encoder 120 of FIG. 1 is illustrated in detail.

Referring to FIG. 4, the video encoder includes a BACT unit 410, a transform and quantization unit 420, an inverse transform and inverse quantization unit 430, a frame memory unit 440, an intra prediction unit 450, a motion compensation and estimation (MC/ME) unit 460, an entropy encoding unit 470, an inverse BACT unit 480, a second BACT unit 412, and an addition unit 490.

Here, the BACT unit 410 and the inverse BACT unit 480 function in the same way as those in FIG. 1 and thus will not be described in detail.

The transform and quantization unit 420 transforms input color-transformed video data to remove spatial redundancy of the video data. By quantizing transform coefficients obtained by transform encoding according to a predetermined quantization step, two-dimensional N×M data composed of the quantized transform coefficients is obtained. For video transform, discrete cosine transform (DCT) may be used. The quantization is performed according to a predetermined quantization step.

The inverse transform and inverse quantization unit 430 performs inverse quantization on the video data quantized by the transform and quantization unit 420, and performs inverse transform, e.g., inverse DCT, on the inversely quantized video data.

The frame memory unit 440 stores final reconstructed video data passing through inverse quantization and inverse transform by the inverse transform and inverse quantization unit 430 and inverse BACT by the inverse BACT unit 480, and outputs the final reconstructed video data to the MC/ME unit 460 via the second BACT unit 412.

The second BACT unit 412 receives the color transformation function for the current block from the BACT unit 410, and performs color transformation by applying the received color transformation function on video data of a previous frame prior to motion compensation and prediction.

The intra prediction unit 450 obtains a predictor for each block or macroblock of an intra macroblock in a spatial area in the case of an intra macroblock, subtracts the predictor from the intra macroblock, and outputs a residue to the BACT unit 410. Here, intra prediction is performed on a color-transformed format, which corresponds to the current block and is obtained by the BACT unit 410.

The MC/ME unit 460 estimates a motion vector and a sum of absolute differences (SAD) for each macroblock using video data of an input current frame and video data of a previous frame stored in the frame memory unit 440 that are processed by color transform. In addition, the MC/ME unit 460 generates a prediction area P that is motion-compensated based on the estimated motion vector, e.g., a 16×16 area selected by motion estimation.

The entropy encoding unit 470 receives information about the quantized transform coefficients output from the transform and quantization unit 420 and the motion vector output from the MC/ME unit 460 to perform entropy encoding, and outputs a finally obtained bitstream.

The addition unit 490 subtracts the motion-compensated prediction area P generated by the MC/ME unit 460 from the input color-transformed current macroblock to generate a residue image. The generated residue image undergoes orthogonal transform like DCT and quantization in the transform and quantization unit 420. The entropy encoding unit 470 generates a bitstream in which header information like coefficient information output from the transform and quantization unit 420 and motion information is compressed by entropy encoding.

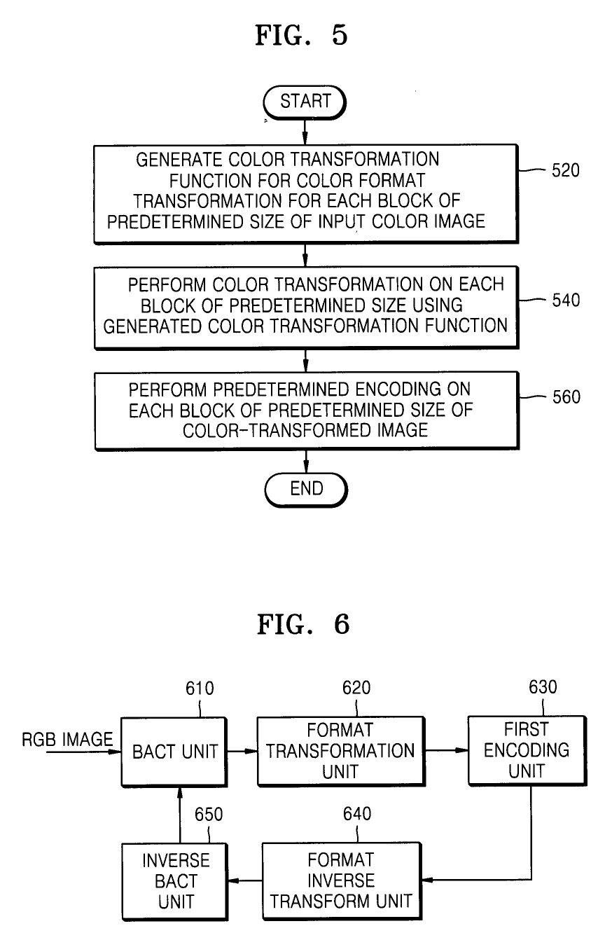

FIG. 5 is a flowchart illustrating a video encoding method implemented by the video encoder illustrated in FIG. 1.

In operation 520, a color transformation function for color format transformation for a plurality of color component images is generated for each input color image, e.g., each block of predetermined size of an RGB image. Here, the color transformation function may be generated using the characteristics of neighboring images of a predetermined-size current block, e.g., neighboring pixel values of the current block for each color component as illustrated in FIGS. 2A through 2C.

In operation 540, color transformation is performed on each of the plurality of color component images of the block of predetermined size using the generated color transformation function.

In operation 560, predetermined encoding is performed on each block of predetermined size of the color-transformed image. The predetermined encoding may be, for example, encoding according to H.264 or MPEG 4 AVC.

FIG. 6 is a block diagram of a video encoder using BACT according to another exemplary embodiment of the present invention.

Referring to FIG. 6, the video encoder includes a BACT unit 610, a format transformation unit 620, a first encoding unit 630, a format inverse transform unit 640, and an inverse BACT unit 650.

The format transformation unit 620 performs format transformation on a color-transformed image, e.g., transforms a 4:4:4 format into a 4:2:0 format, and outputs the format-transformed image to the first encoding unit 630.

The format inverse transform unit 640 inversely transforms the format of the image output from the first encoding unit 630, and outputs the format-inversely-transformed image to the inverse BACT unit 650. For example, the format transformed into the 4:2:0 format is inversely transformed into the 4:4:4 format.

The format transformation and the format inverse transform may be performed by a down sampler such as a 4:4:4-to-4:2:0 converter and an up sampler such as a 4:2:0-to-4:4:4 converter. In addition, not only transform from the 4:4:4 format to the 4:2:0 format but also transform from the 4:4:4 format to other ratio formats can be performed. For example, transform from the 4:4:4 format to a 4:2:2 format may be performed. At this time, the transform and the inverse transform may be performed by a 4:4:4-to-4:2:2 converter and a 4:2:2-to-4:4:4 converter.

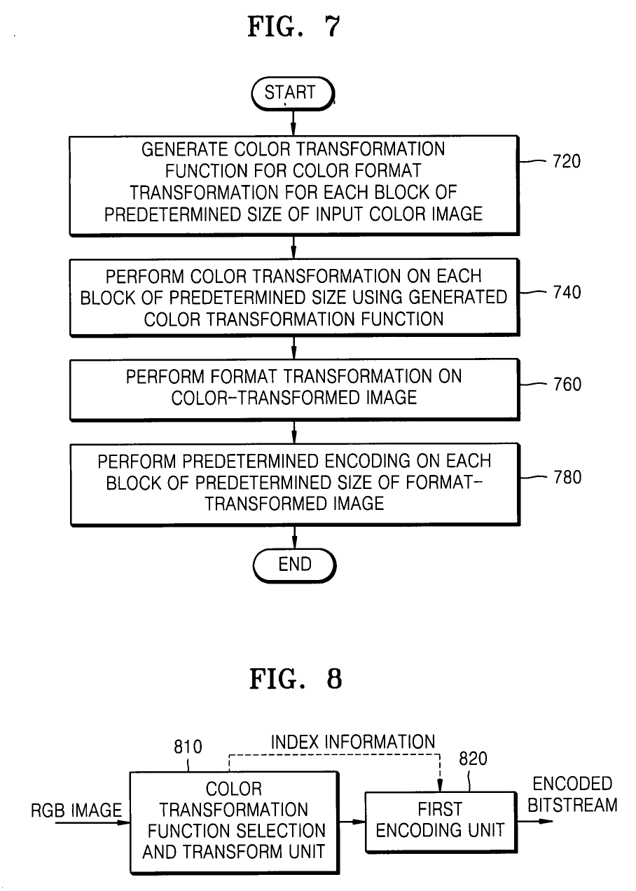

FIG. 7 is a flowchart illustrating a video encoding method implemented by the video encoder illustrated in FIG. 6.

In operation 720, a color transformation function for color format transformation for a plurality of color component images is generated for each input color image, e.g., each block of predetermined size of an RGB image. Here, the color transformation function may be generated using the characteristics of neighboring images of a predetermined-size current block, e.g., neighboring pixel values of the current block for each color component as illustrated in FIGS. 2A through 2C.

In operation 740, color transformation is performed on each of the plurality of color component images of the block of predetermined size using the generated color transformation function.

In operation 760, the format of the color-transformed image is transformed. In the current exemplary embodiment, the format transformation is one of transform from a 4:4:4 format to a 4:2:0 format, transform from the 4:4:4 format to a 4:2:2 format, transform from the 4:2:0 format to the 4:4:4 format, and transform from the 4:2:2 format to the 4:4:4 format. Optionally, the transform may be performed to other ratio formats.

In operation 780, predetermined encoding is performed on each block of predetermined size of the format-transformed image. The predetermined encoding may be, for example, encoding according to H.264 or MPEG 4 AVC.

FIG. 8 is a block diagram of a video encoder using BACT according to another exemplary embodiment of the present invention.

Referring to FIG. 8, the video encoder includes a color transformation function selection and transform unit 810, a color transformation function storing unit (not shown), and a first encoding unit 820.

The color transformation function selection and transform unit 810 selects one of a plurality of color transformation functions for color format transformation stored in the color transformation function storing unit for each block of predetermined size, e.g., each 16×16 block of a color image, and performs color transformation on the block of predetermined size using the selected color transformation function.

Here, the selection of the color transformation function can be made by performing a plurality of color transforms on each block of predetermined size of the color image, performing encoding on each block of predetermined size of the color-transformed color image, and selecting a color transformation function resulting in the smallest amount of bits. The selection of the color transformation function may also be made by selecting one of the stored color transformation functions based on the characteristics of neighboring images of the current block. Here, the color transformation function may be one of YCbCr, YFbFr, and YCoCg transformation functions, but may be one of other color transformation functions. Index information indicating the selected color transformation function is also transmitted to the first encoding unit 820, together with the color-transformed image.

The first encoding unit 820 performs predetermined encoding on the color-transformed image. The first encoding unit 820 also generates and transmits an encoded bitstream including the index information indicating the selected color transformation function and the encoded color-transformed image.

Optionally, the video encoder illustrated in FIG. 8 may further include a format transformation unit (not shown) for performing the same function as the format transformation unit 620 of FIG. 6.

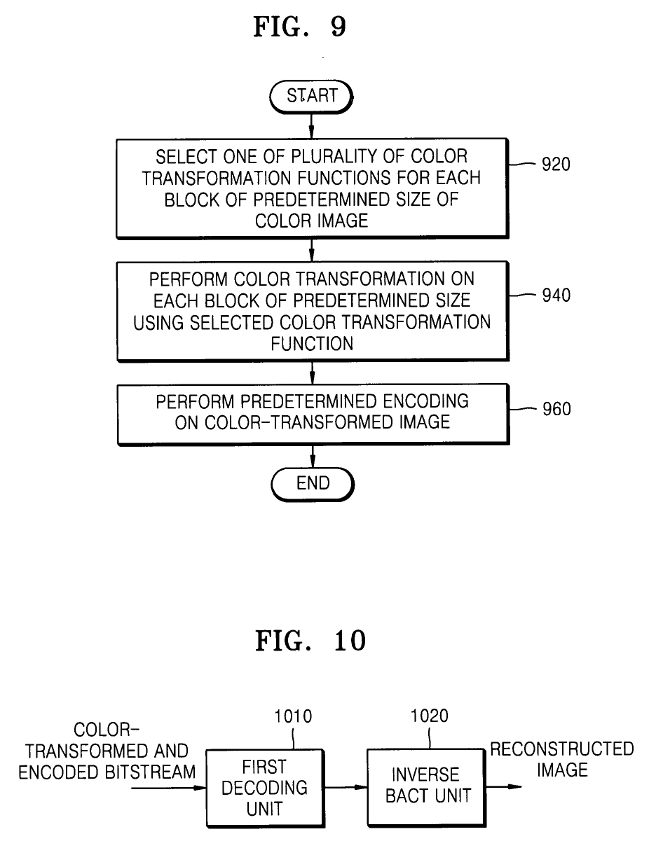

FIG. 9 is a flowchart illustrating a video encoding method implemented by the video encoder illustrated in FIG. 8.

In operation 920, one of a plurality of color transformation functions for color format transformation is selected for each color image, e.g., each block of predetermined size of a color image. The selection of the color transformation function may be made by performing a plurality of color transforms on each block of predetermined size of the color image, performing encoding on each block of predetermined size of the color-transformed color image, and selecting a color transformation function resulting in the smallest amount of bits. In addition, the selection of the color transformation function may be made based on the characteristics of neighboring images of the current block, e.g., the average of neighboring pixel values of the current block for each color component. Index information indicating the selected color transformation function may be inserted into the encoded bitstream for transmission. The plurality of color transformation functions may be YCbCr, YFbFr, and YCoCg transformation functions.

In operation 940, color transformation is performed on each of a plurality of color component images of the block of predetermined size using the color transformation function selected in operation 920.

In operation 960, predetermined encoding is performed on the color-transformed image.

Format transformation may be further included after the color transformation of operation 940. Here, the format transformation may be one of transform from a 4:4:4 format to a 4:2:0 format, transform from the 4:4:4 format to a 4:2:2 format, transform from the 4:2:0 format to the 4:4:4 format, and transform from the 4:2:2 format to the 4:4:4 format.

FIG. 10 is a block diagram of a video decoder according to an exemplary embodiment of the present invention.

Referring to FIG. 10, the video decoder includes a first decoding unit 1010 and an inverse BACT unit 1020.

The first decoding unit 1010 receives a color image that undergoes predetermined color transformation and predetermined encoding, in units of a block of predetermined size, performs decoding corresponding to the predetermined encoding on the received color image, and outputs the resulting image to the inverse BACT unit 1020. Here, the first decoding unit 1010 may be a decoder adopting decoding according to H.264 or MPEG 4 AVC.

The inverse BACT unit 1020 generates an inverse color transformation function for color format transformation for each of a plurality of color components of each block of predetermined size, and performs inverse color transformation on each of the color components using the generated inverse color transformation function. In the current exemplary embodiment, the inverse color transformation function is generated based on the characteristics of neighboring images of the current block using Equations 6 through 8. In other words, a color image is an RGB image, and a color transformation function is generated using neighboring pixel values of a predetermined-size current block for each color component or the average of the pixel values.

Optionally, if a bitstream input to the first decoding unit 1010 undergoes format transformation after color transform, it undergoes inverse color transformation in the inverse BACT unit 1020 after format inverse transform in a format inverse transform unit (not shown). The format inverse transform unit functions in the same manner as the format inverse transform unit 640 of FIG. 6, and thus will not be described in detail.

Optionally, if index information specifying color transformation applied to each block of predetermined size is inserted into a bitstream input to the first decoding unit 1010, the inverse BACT unit 1020 selects one of a plurality of inverse color transformation functions stored in an inverse color transformation function storing unit (not shown) based on the inserted index information, and performs inverse color transformation on the color image undergoing first decoding based on the selected inverse color transformation function.

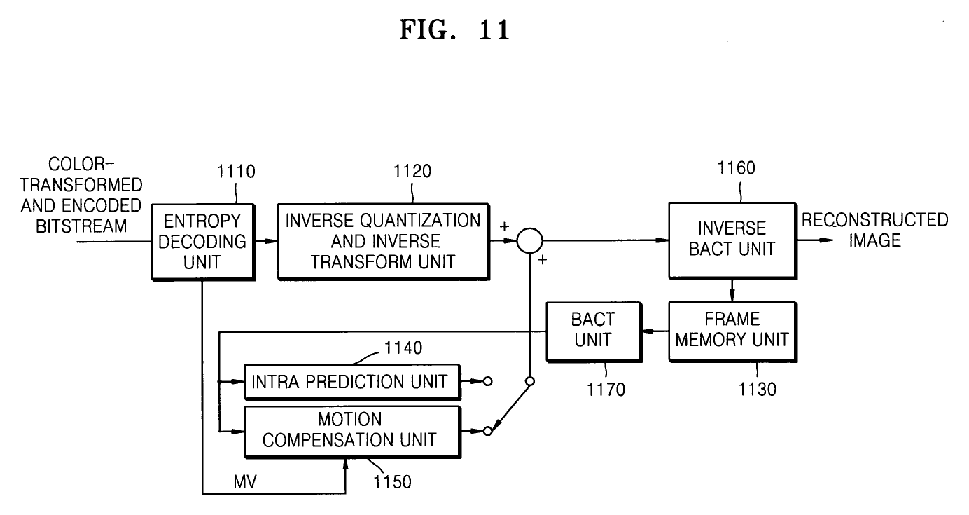

FIG. 11 is a block diagram of a video decoder in which the first decoding unit 1010 of FIG. 10 is illustrated in detail.

Referring to FIG. 11, the video decoder includes an entropy decoding unit 1110, an inverse quantization and inverse transform unit 1120, a frame memory unit 1130, an intra prediction unit 1140, a motion compensation unit 1150, an inverse BACT unit 1160, and a BACT unit 1170.

The entropy decoding unit 1110 performs entropy decoding on an input encoded stream to extract video data and motion vector information. The entropy-decoded video data is input to the inverse quantization and inverse transform unit 1120, and the motion vector information is input to the motion compensation unit 1150.

For example, the video data undergoes inverse transform and inverse quantization in the inverse transform and inverse quantization unit 1120, and the resulting data is added to a predictor, e.g., a prediction area that is motion compensated by the motion compensation unit 1150 to generate a reconstructed image. The reconstructed image is output to the inverse BACT unit 1160.

The BACT unit 1170 transforms the format of input data into a predetermined color format using a color transformation function corresponding to an inverse color transformation function used in the inverse BACT unit 1160, and outputs the color-format transformed data to the intra prediction unit 1140 or the motion compensation unit 1150.

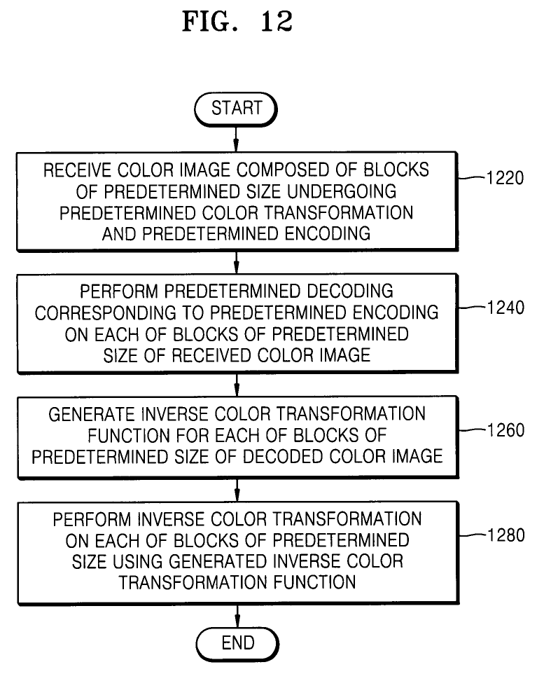

FIG. 12 is a flowchart illustrating a video decoding method implemented by the video decoder illustrated in FIG. 10.

In operation 1220, a color image composed of blocks of predetermined size undergoing predetermined color transformation and predetermined encoding is received.

In operation 1240, predetermined decoding corresponding to the predetermined encoding is performed on each of the blocks of predetermined size of the received color image.

In operation 1260, an inverse color transformation function for color format transformation is generated for each of a plurality of color component images of each of the blocks of predetermined size of the decoded color image. Here, the color transformation function is generated using the characteristics of neighboring images of the predetermined-size current block, e.g., neighboring pixel values of the current block for each color component as illustrated in FIGS. 2A through 2C.

In operation 1280, inverse color transformation is performed on each of the plurality of color component images of the block of predetermined size using the generated inverse color transformation function.

Optionally, if the received color image undergoes one of transform from a 4:4:4 format to a 4:2:0 format, transform from the 4:4:4 format to a 4:2:2 format, transform from the 4:2:0 format to the 4:4:4 format, and transform from the 4:2:2 format to the 4:4:4 format, inverse format transformation corresponding to format transformation may be further included prior to the inverse color transformation.

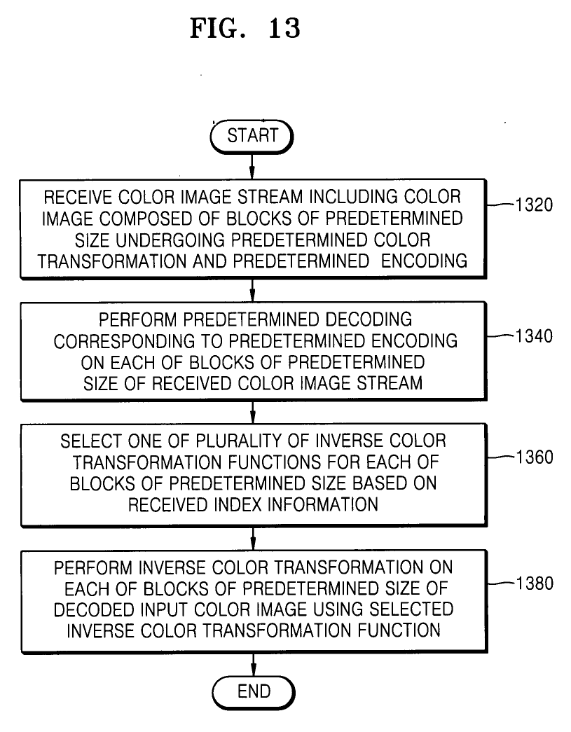

FIG. 13 is a flowchart illustrating a video decoding method implemented by the video decoder illustrated in FIG. 11.

In operation 1320, a color image stream including a color image that undergoes predetermined color transformation and predetermined encoding and index information specifying color transformation applied to each of predetermined-size blocks is received in units of the block of predetermined size.

In operation 1340, predetermined decoding corresponding to the predetermined encoding is performed on each of the blocks of predetermined size of the received color image stream that undergoes the color transformation and the encoding in units of the block of predetermined size.

In operation 1360, one of a plurality of inverse color transformation functions for color format transformation is selected based on the received index information for each of a plurality of color component images of each of the blocks of predetermined size of the decoded input color image. Here, the plurality of color transformation functions may be YCbCr, YFbFr, and YCoCg transformation functions.

In operation 1380, inverse color transformation is performed for each of the plurality of color component images of each of the blocks of predetermined size of the input color image that undergoes the predetermined decoding, using the selected inverse color transformation function.

If the received color image undergoes one of transform from a 4:4:4 format to a 4:2:0 format, transform from the 4:4:4 format to a 4:2:2 format, transform from the 4:2:0 format to the 4:4:4 format, and transform from the 4:2:2 format to the 4:4:4 format, inverse format transformation corresponding to format transformation may be further included prior to the inverse color transformation after the predetermined decoding.

Although color transformation is performed on each block of predetermined size for video encoding or reconstruction, color transformation may also be performed on each slice or picture and video information included in the slice or the picture may be encoded or decoded in units of a predetermined-size bock.

Meanwhile, the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to exemplary embodiments of the present invention, color transformation and encoding is performed based on the local characteristic of an image by performing adaptive color transformation on each block of predetermined size, thereby improving encoding efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a color image, the method comprising:
generating a color transformation function for color format transformation for each block of the color image;
performing color transformation on each block of the color image using the color transformation function; and
performing encoding on each block of the color-transformed image.

2. The method of claim 1, wherein the color transformation function is generated using characteristics of neighboring images of the block.

3. The method of claim 1, wherein the color image is an RGB image, and the color transformation function is generated using neighboring pixel values of the block for each color component.

4. The method of claim 1, further comprising performing format transformation after the performing the color transformation, wherein the format transformation is one of transformation from a 4:4:4 format to a 4:2:0 format, transformation from the 4:4:4 format to a 4:2:2 format, transformation from the 4:2:0 format to the 4:4:4 format, and transformation from the 4:2:2 format to the 4:4:4 format.

5. A method of encoding a color image, the method comprising:
selecting a color transformation function from a plurality of color transformation functions for color format transformation for each block of the color image;
performing color transformation on each block of the color image using the color transformation function; and
performing encoding on each block of the color-transformed color image.

6. The method of claim 5, wherein the selecting the color transformation function comprises performing a plurality of color transformations on each block of the color image, performing encoding on each block of the color-transformed color image, and selecting the color transformation function resulting in a smallest amount of bits.

7. The method of claim 5, wherein mode information indicating the color transformation function is inserted into an encoded bitstream for transmission.

8. The method of claim 5, wherein the plurality of color transformation functions comprise YCbCr, YFbFr, and YCoCg transformation functions.

9. A method of decoding a color image, the method comprising:
receiving the color image composed of blocks undergoing color transformation and encoding;
performing decoding corresponding to the encoding on the color image;
generating an inverse color transformation function for color format transformation for each of the blocks of the color image; and
performing inverse color transformation on each of the blocks of the color image using the inverse color transformation function.

10. The method of claim 9, wherein the inverse color transformation function is generated using characteristics of neighboring images of the blocks.

11. A method of decoding a color image, the method comprising:
receiving a color image stream including a color image composed of blocks undergoing color transformation and encoding and mode information specifying the color transformation applied to each of the blocks of the color image;
performing decoding corresponding to the encoding on each of the blocks of the color image stream;
selecting an inverse color transformation function from a plurality of inverse color transformation functions for color format transformation for each of the blocks of the color image based on the mode information; and
performing inverse color transformation on each of the blocks of the color image using the inverse color transformation function.

12. The method of claim 11, wherein the plurality of inverse color transformation functions comprise YCbCr, YFbFr, and YCoCg transformation functions.

13. An apparatus for encoding a color image, the apparatus comprising:
a color transformation function generation unit which generates a color transformation function for color format transformation for each block of the color image;
a color transformation unit which performs color transformation on each block of the color image using the color transformation function; and
an encoding unit which performs encoding on each block of the color-transformed image.

14. The apparatus of claim 13, wherein the color transformation function generation unit generates the color transformation function using characteristics of neighboring images of the block.

15. An apparatus for encoding a color image, the apparatus comprising:
a color transformation function selection unit which selects a color transformation function from a plurality of color transformation functions for color format transformation for each block of the color image;
a color transformation unit which performs color transformation on each block of the color image using the color transformation function; and
an encoding unit which performs encoding on each block of the color-transformed color image.

16. The apparatus of claim 15, wherein the color transformation function selection unit selects the color transformation function from the plurality of color transformation functions by performing a plurality of color transformations on each block of the color image, performing encoding on each block of the color-transformed color image, and selecting the color transformation function resulting in the smallest amount of bits.

17. The apparatus of claim 15, wherein the color transformation function selection unit selects the color transformation function from the plurality of color transformation functions based on characteristics of neighboring images of the block.

18. The apparatus of claim 15, wherein index information indicating the color transformation function is inserted into an encoded bitstream for transmission.

19. An apparatus for decoding a color image, the apparatus comprising:
a decoding unit which receives the color image composed of blocks undergoing color transformation and encoding, and performs decoding corresponding to the encoding on the color image; and
an inverse color transformation unit which generates an inverse color transformation function for color format transformation for each of the blocks of the color image, and performs inverse color transformation on each of the blocks of the color image using the inverse color transformation function.

20. The apparatus of claim 19, wherein the inverse color transformation unit generates the inverse color transformation function using characteristics of neighboring images of the blocks.

21. An apparatus for decoding a color image, the apparatus comprising:
a decoding unit which receives a color image stream including a color image composed of blocks undergoing color transformation and encoding and mode information specifying the color transformation applied to each of the blocks of the color image, and performs decoding corresponding to the encoding on each of the blocks of the color image stream; and
an inverse color transformation unit which selects an inverse color transformation function from a plurality of inverse color transformation functions for color format transformation for each of the blocks of the color image based on the mode information, and performs inverse color transformation on each of the blocks of the color image using the inverse color transformation function.

22. A computer readable recording medium storing a computer program for performing a method of encoding a color image, the method comprising:
generating a color transformation function for color format transformation for each block of the color image;
performing color transformation on each block of the color image using the color transformation function; and
performing encoding on each block of the color-transformed image.

23. A computer readable recording medium storing a computer program for performing a method of encoding a color image, the method comprising:
selecting a color transformation function from a plurality of color transformation functions for color format transformation for each block of the color image;
performing color transformation on each block of the color image using the color transformation function; and
performing encoding on each block of the color-transformed color image.

24. A computer readable recording medium storing a computer program for performing a method of decoding a color image, the method comprising:
receiving the color image composed of blocks undergoing color transformation and encoding;
performing decoding corresponding to the encoding on the color image;
generating an inverse color transformation function for color format transformation for each of the blocks of the color image; and
performing inverse color transformation on each of the blocks of the color image using the inverse color transformation function.

25. A computer readable recording medium storing a computer program for performing a method of decoding a color image, the method comprising:
receiving a color image stream including a color image composed of blocks undergoing color transformation and encoding and mode information specifying the color transformation applied to each of the blocks of the color image;
performing decoding corresponding to the encoding on each of the blocks of the color image stream;
selecting an inverse color transformation function from a plurality of inverse color transformation functions for color format transformation for each of the blocks of the color image based on the mode information; and
performing inverse color transformation on each of the blocks of the color image using the inverse color transformation function.
